(19) United States
(12) Patent Application Publication
(10) Pub. No.: US 2026/0125070 A1
(43) Pub. Date: May 7, 2026

(54) DETECTION AND RESOLUTION OF IMPLAUSIBLE DRIVER INPUT

(71) Applicant: GM Global Technology Operations LLC, Detroit, MI (US)

(72) Inventors: Milad Jalaliyazdi, Richmond Hill (CA); Reza Zarringhalam, Whitby (CA); Kevin Gady, Saline, MI (US)

(21) Appl. No.: 18/940,326

(22) Filed: Nov. 7, 2024

(51) Int. Cl. B60W 50/10; B60W 30/095; B60W 50/12; B60W 50/14

(52) U.S. Cl. CPC B60W 50/10; B60W 30/0953; B60W 50/12; B60W 50/14; B60W 2540/10; B60W 2540/12

(57) ABSTRACT

A system for intervening and resolving implausible driver input in a vehicle that is being operated in a manual mode includes a system controller in communication with a plurality of sensors within the vehicle, the system controller adapted to receive data, from the plurality of sensors within the vehicle, related to operating conditions of the vehicle, detect, via communication with the plurality of sensors, an input received from the driver of the vehicle, determine if the input received from the driver is an implausible action, and, when the system controller determines that the input received from the driver of the vehicle is implausible, disable inhibit software within the system controller, enabling intervention by the system controller, and intervene, by taking control of at least one vehicle system, to resolve the implausible driver input.

### INTRODUCTION

The present disclosure relates to a system for detecting implausible driver input and utilizing an advanced driver assistance system (ADAS) to resolve implausible driver input.

ADAS within a vehicle is equipped to intervene in certain circumstances, taking over control of specific vehicle function to keep the vehicle on an appropriate trajectory. ADAS is adapted to intervene only when an action of the vehicle, such as drifting toward a lane marker of a lane within which the vehicle is traveling, appears to be unintended by the driver. ADAS inhibit software prevents the ADAS from intervening in circumstances where a driver is actively controlling the vehicle.

Thus, while current methods and systems achieve their intended purpose, there is a need for a new and improved system that disables ADAS inhibit software to allow ADAS intervention when active input by the driver is determined to be implausible.

### SUMMARY

According to several aspects of the present disclosure, a method of intervening and resolving implausible driver input in a vehicle that is being operated in a manual mode includes receiving data, from a plurality of sensors within the vehicle, related to operating conditions of the vehicle, detecting, with a system controller, via communication with the plurality of sensors, an input received from the driver of the vehicle, determining, with the system controller, if the input received from the driver is an implausible action, and, when the system controller determines that the input received from the driver of the vehicle is implausible, disabling inhibit software within the system controller, enabling intervention by the system controller, and intervening, with the system controller, control of at least one vehicle system to resolve the implausible driver input.

According to another aspect, the detecting, with a system controller, via communication with the plurality of sensors, an input received from a driver of the vehicle further includes detecting, with the system controller, via communication with the plurality of sensors, actuation, by the driver, of a turn signal, and, the determining, with the system controller, if the input received from the driver is an implausible action further includes determining, with the system controller, that actuation of the turn signal by the driver is an implausible action, determining, with the system controller, if the detected actuation of the turn signal by the driver has been attempted by the driver more than one time, when the turn signal has been actuated by the driver more than one time, taking no further action, and, when the turn signal has been actuated by the driver one time, the intervening, with the system controller, control of at least one vehicle system to resolve the implausible driver input further includes disabling, with the system controller, the turn signal.

According to another aspect, the detecting, with a system controller, via communication with the plurality of sensors, an input received from the driver of the vehicle further includes detecting, with the system controller, via communication with the plurality of sensors, simultaneous actuation, by the driver, of a brake pedal and an accelerator pedal, and the determining, with the system controller, if the input received from the driver is an implausible action further including determining, with the system controller, if simultaneous actuation, by the driver, of the brake pedal and the accelerator pedal is an implausible action, and, probabilistically calculating, with the system controller, a probability of a collision event in response to simultaneous actuation, by the driver, of the brake pedal and the accelerator pedal, when the probability of a collision event is more than a first threshold and less than a second threshold, determining that simultaneous actuation, by the driver, of the brake pedal and the accelerator pedal causes a low risk of a collision event, and the intervening, with the system controller, control of at least one vehicle system to resolve the implausible driver input further includes providing, via a human machine interface (HMI) within the vehicle an alert for the driver, and, when the probability of a collision event is more than the second threshold, determining that simultaneous actuation, by the driver, of the brake pedal and the accelerator pedal causes a high risk of a collision event, and the intervening, with the system controller, control of at least one vehicle system to resolve the implausible driver input further includes de-activating actuation of one of the brake pedal and the accelerator pedal.

According to another aspect, when the system controller determines that simultaneous actuation, by the driver, of the brake pedal and the accelerator pedal causes a high risk of a collision event, the intervening, with the system controller, control of at least one vehicle system to resolve the implausible driver input further includes providing, with the system controller, via the HMI, an alert notification explaining that both the brake pedal and the accelerator pedal are being actuated and the system is de-activating actuation of one of the brake pedal and the accelerator pedal.

According to another aspect, the detecting, with a system controller, via communication with the plurality of sensors, an input received from the driver of the vehicle further includes determining, with the system controller, based on the data received from the plurality of sensors, a location of the vehicle in a controlled environment and a presence of at least one vulnerable road user (VRU) in proximity to the vehicle and detecting, with the system controller, via communication with the plurality of sensors, a hard actuation of an accelerator pedal within the vehicle when the vehicle is located in a controlled environment and at least one VRU is in proximity to the vehicle, and, the determining, with the system controller, if the input received from the driver is an implausible action further including determining, with the system controller, if the hard actuation of the accelerator pedal by the driver is an implausible action, and probabilistically calculating, with the system controller, a probability of a collision event in response to the hard actuation of the accelerator pedal, when the probability of a collision event is more than a first threshold and less than a second threshold, determining that the hard actuation of the accelerator pedal causes a low risk of a collision event, and the intervening, with the system controller, control of at least one vehicle system to resolve the implausible driver input further includes providing, via a human machine interface (HMI) within the vehicle an alert for the driver, and, when the probability of a collision event is more that the second threshold, determining that the hard actuation of the accelerator pedal by the driver causes a high risk of a collision event, and the intervening, with the system controller, control of at least one vehicle system to resolve the implausible driver input further includes limiting, with the system controller, actuation of the accelerator pedal.

According to another aspect, when the system controller determines that the hard actuation of the accelerator pedal causes a high risk of a collision event, the intervening, with the system controller, control of at least one vehicle system to resolve the implausible driver input further includes providing, with the system controller, via the HMI, an alert notification explaining that the system will not allow hard acceleration of the vehicle and actuation of the accelerator pedal is being limited.

According to another aspect, the detecting, with a system controller, via communication with the plurality of sensors, an input received from the driver of the vehicle further includes determining, with the system controller, based on the data received from the plurality of sensors and a driver monitoring system, the driver of the vehicle is distracted, and, detecting, with the system controller, via communication with the plurality of sensors, actuation, by the driver, of at least one of an accelerator pedal and a steering wheel within the vehicle while the driver is distracted, and the determining, with the system controller, if the input received from the driver is an implausible action further including determining, with the system controller, if the actuation, by the driver, of at least one of an accelerator pedal and a steering wheel within the vehicle is an implausible action, and probabilistically calculating, with the system controller, a probability of a collision event in response to the actuation, by the driver, of at least one of the accelerator pedal and the steering wheel within the vehicle, when the probability of a collision event is more than a first threshold and less than a second threshold, determining that the actuation, by the driver, of at least one of the accelerator pedal and the steering wheel within the vehicle causes a low risk of a collision event, and the intervening, with the system controller, control of at least one vehicle system to resolve the implausible driver input further includes providing, via a human machine interface (HMI) within the vehicle, an alert for the driver, and, when the probability of a collision event is more that the second threshold, determining that the actuation, by the driver, of at least one of the accelerator pedal and the steering wheel within the vehicle causes a high risk of a collision event, and the intervening, with the system controller, control of at least one vehicle system to resolve the implausible driver input further includes at least one of de-activating, with the system controller, actuation of the accelerator pedal, actuating, with the system controller, a brake system within the vehicle, and actuating, with the system controller, a steering system.

According to another aspect, when the system controller determines that actuation, by the driver, of at least one of the accelerator pedal and the steering wheel within the vehicle causes a high risk of a collision event, the intervening, with the system controller, control of at least one vehicle system to resolve the implausible driver input further includes providing, with the system controller, via the HMI, an alert notification explaining that the system controller is intervening to limit actuation of the accelerator pedal, actuating a brake system within the vehicle, and enabling lane keeping assist features of the system controller to override input to the steering wheel.

According to another aspect, the determining, with the system controller, if the input received from the driver is an implausible action further includes, prior to the intervening, with the system controller, control of at least one vehicle system to resolve the implausible driver input, verifying, with the system controller, that enabling conditions are satisfied for intervention by the system controller.

According to another aspect, the determining, with the system controller, if the input received from the driver is an implausible action further includes predicting and mapping, with the system controller, an apparent trajectory of the vehicle, an actual trajectory of the vehicle based on the detected driver input, and plausible trajectories for the vehicle.

According to several aspects of the present disclosure, a system for intervening and resolving implausible driver input in a vehicle that is being operated in a manual mode includes a system controller in communication with a plurality of sensors within the vehicle, the system controller adapted to receive data, from the plurality of sensors within the vehicle, related to operating conditions of the vehicle, detect, via communication with the plurality of sensors, an input received from the driver of the vehicle, determine if the input received from the driver is an implausible action, and, when the system controller determines that the input received from the driver of the vehicle is implausible, disable inhibit software within the system controller, enabling intervention by the system controller, and intervene, by taking control of at least one vehicle system, to resolve the implausible driver input.

According to another aspect, the system controller is adapted to detect actuation, by the driver, of a turn signal, and, when determining if the input received from the driver is an implausible action, determine if actuation of the turn signal by the driver is an implausible action, determine, with the system controller, if the detected actuation of the turn signal by the driver has been attempted by the driver more than one time, when the turn signal has been actuated by the driver more than one time, take no further action, and, when the turn signal has been actuated by the driver one time, when intervening to take control of at least one vehicle system to resolve the implausible driver input, the system controller is further adapted to disable the turn signal.

According to another aspect, when detecting, via communication with the plurality of sensors, an input received from the driver of the vehicle, the system controller is further adapted to detect, via communication with the plurality of sensors, simultaneous actuation, by the driver, of a brake pedal and an accelerator pedal, and, when determining if the input received from the driver is an implausible action, the system controller is further adapted to determine if simultaneous actuation, by the driver, of the brake pedal and the accelerator pedal is an implausible action, and probabilistically calculate a probability of a collision event in response to simultaneous actuation, by the driver, of the brake pedal and the accelerator pedal, when the probability of a collision event is more than a first threshold and less than a second threshold, determine that simultaneous actuation, by the driver, of the brake pedal and the accelerator pedal causes a low risk of a collision event, and, when intervening to take control of at least one vehicle system to resolve the implausible driver input, provide, via a human machine interface (HMI) within the vehicle, an alert for the driver, and, when the probability of a collision event is more that the second threshold, determine that simultaneous actuation, by the driver, of the brake pedal and the accelerator pedal causes a high risk of a collision event, and, when intervening to take control of at least one vehicle system to resolve the implausible driver input, de-activate actuation of one of the brake pedal and the accelerator pedal.

According to another aspect, when the system controller determines that simultaneous actuation, by the driver, of the brake pedal and the accelerator pedal causes a high risk of a collision event, when intervening to take control of at least one vehicle system to resolve the implausible driver input, the system controller is further adapted to provide, via the HMI, an alert notification explaining that both the brake pedal and the accelerator pedal are being actuated and the system controller is de-activating actuation of one of the brake pedal and the accelerator pedal.

According to another aspect, the system controller is further adapted to determine, based on the data received from the plurality of sensors, a location of the vehicle in a controlled environment and a presence of at least one vulnerable road user (VRU) in proximity to the vehicle, wherein, when detecting, via communication with the plurality of sensors, an input received from the driver of the vehicle, the system controller is adapted to detect, via communication with the plurality of sensors, a hard actuation of an accelerator pedal within the vehicle when the vehicle is located in a controlled environment and at least one VRU is in proximity to the vehicle, and, when determining if the input received from the driver is an implausible action, the system controller is further adapted to determine if the hard actuation of the accelerator pedal by the driver is an implausible action, and probabilistically calculate a probability of a collision event in response to the hard actuation of the accelerator pedal, when the probability of a collision event is more than a first threshold and less than a second threshold, determine that the hard actuation of the accelerator pedal causes a low risk of a collision event, and, when intervening to take control of at least one vehicle system to resolve the implausible driver input, provide, via a human machine interface (HMI) within the vehicle an alert for the driver, and, when the probability of a collision event is more that the second threshold, determine that the hard actuation of the accelerator pedal by the driver causes a high risk of a collision event, and, when intervening to take control of at least one vehicle system to resolve the implausible driver input, limit actuation of the accelerator pedal.

According to another aspect, when the system controller determines that the hard actuation of the accelerator pedal causes a high risk of a collision event, when intervening to take control of at least one vehicle system to resolve the implausible driver input, the system controller is further adapted to provide, via the HMI, an alert notification explaining that the system controller will not allow hard acceleration of the vehicle and actuation of the accelerator pedal is being limited.

According to another aspect, the system controller is further adapted to determine, based on the data received from the plurality of sensors and an occupant monitoring system, the driver of the vehicle is distracted, wherein, when detecting, via communication with the plurality of sensors, an input received from the driver of the vehicle, the system controller is further adapted to detect, via communication with the plurality of sensors, actuation, by the driver, of at least one of an accelerator pedal and a steering wheel within the vehicle while the driver is distracted, and, when determining if the input received from the driver is an implausible action, the system controller is further adapted to determine if the actuation, by the driver, of at least one of an accelerator pedal and a steering wheel within the vehicle is an implausible action, and probabilistically calculate a probability of a collision event in response to the actuation, by the driver, of at least one of the accelerator pedal and the steering wheel within the vehicle, and, wherein, when the probability of a collision event is more than a first threshold and less than a second threshold, determine that the actuation, by the driver, of at least one of the accelerator pedal and the steering wheel within the vehicle causes a low risk of a collision event, and, when intervening to take control of at least one vehicle system to resolve the implausible driver input, to provide, via a human machine interface (HMI) within the vehicle, an alert for the driver, and, when the probability of a collision event is more that the second threshold, determine that the actuation, by the driver, of at least one of the accelerator pedal and the steering wheel within the vehicle causes a high risk of a collision event, and, when intervening to take control of at least one vehicle system to resolve the implausible driver input, at least one of de-activate actuation of the accelerator pedal, actuate brakes within the vehicle, and actuate a steering system.

According to another aspect, when the system controller determines that actuation, by the driver, of at least one of the accelerator pedal and the steering wheel within the vehicle causes a high risk of a collision event, when intervening to take control of at least one vehicle system to resolve the implausible driver input, the system controller is further adapted to provide, via the HMI, an alert notification explaining that the system controller is intervening to prevent actuation of the accelerator pedal and enabling lane-assist features within the vehicle to override input to the steering wheel.

According to another aspect, prior to the intervening to take control of at least one vehicle system to resolve the implausible driver input, the system controller is further adapted to verify that enabling conditions are satisfied for intervention by the system controller, and when determining if the input received from the driver is an implausible action, the system controller is further adapted to predict and map an apparent trajectory of the vehicle, an actual trajectory of the vehicle based on the detected driver input, and plausible trajectories for the vehicle.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a vehicle including a system according to an exemplary embodiment of the present disclosure;

FIG. 2 is a schematic diagram of the system;

FIG. 3 is a flow chart illustrating a method of operating the system of FIG. 1;

FIG. 4 is a flow chart illustrating an exemplary embodiment of the method wherein the detected driver input is actuation of a turn signal; and

FIG. 5 is a flow chart illustrating an exemplary embodiment of the method wherein the risk of a collision event is determined to be a low risk or a high risk.

The figures are not necessarily to scale and some features may be exaggerated or minimized, such as to show details of particular components. In some instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to variously employ the present disclosure.

### DETAILED DESCRIPTION

The following description is merely exemplary in nature and is not intended to limit the present disclosure, application, or uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: an electronic circuit, a processor (shared, dedicated, or group) and memory that executes one or more software or firmware programs, a combinational logic circuit, and/or other suitable components that provide the described functionality. Although the figures shown herein depict an example with certain arrangements of elements, additional intervening elements, devices, features, or components may be present in actual embodiments. It should also be understood that the figures are merely illustrative and may not be drawn to scale.

As used herein, the term “vehicle” is not limited to automobiles. While the present technology is described primarily herein in connection with automobiles, the technology is not limited to automobiles. The concepts can be used in a wide variety of applications, such as in connection with aircraft, marine craft, other vehicles, and consumer electronic components.

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about”, with reference to percentages, comprises a variation of plus/minus 5%, “about”, with reference to temperatures, comprises a variation of plus/minus five degrees, and “about”, with reference to distances, comprises plus/minus 10%. In addition, disclosure of ranges includes disclosure of all values and further divided ranges within the entire range, including endpoints and sub-ranges given for the ranges. In addition, disclosure of ranges includes disclosure of all values and further divided ranges within the entire range, including endpoints and sub-ranges given for the ranges.

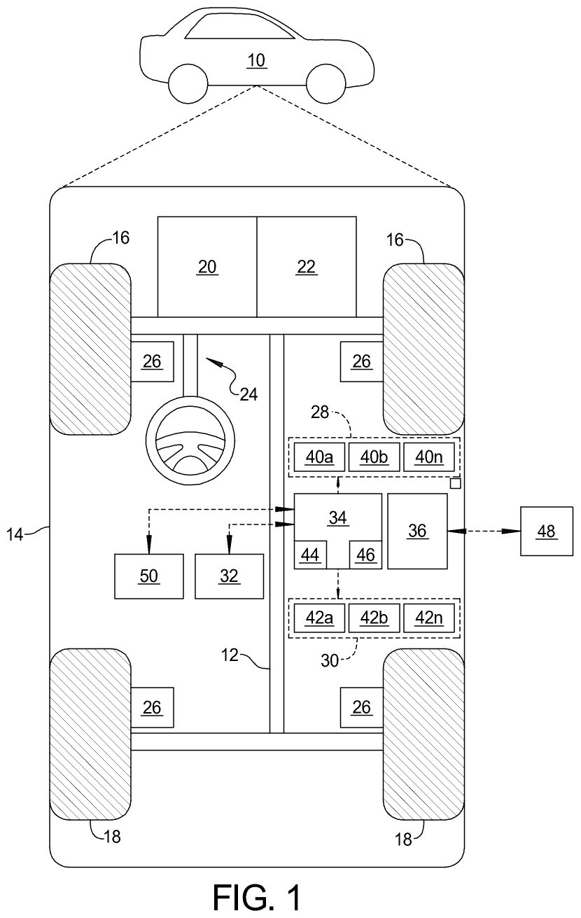

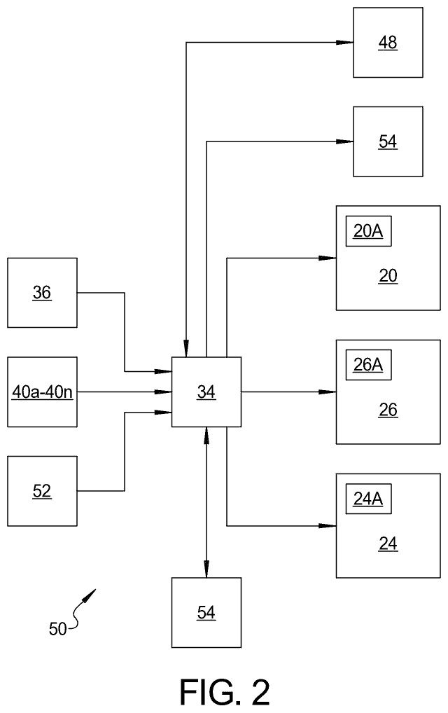

Example embodiments will now be described more fully with reference to the accompanying drawings. In accordance with an exemplary embodiment, FIG. 1 shows a vehicle 10 with an associated system 50 adapted to provide advanced driver assistance capabilities (ADAS) for the vehicle 10, and, when the vehicle 10 is operating in a manual mode of operation (driver controls all functions, autonomous driving dis-abled) to disable ADAS inhibit software to allow ADAS intervention when active input by a driver is determined to be implausible.

The vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The front wheels 16 and rear wheels 18 are each rotationally coupled to the chassis 12 near a respective corner of the body 14.

In various embodiments, the vehicle 10 is an autonomous vehicle and the system 50 is incorporated into the autonomous vehicle 10. An autonomous vehicle 10 is, for example, a vehicle 10 that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), etc., can also be used. In an exemplary embodiment, the vehicle 10 is equipped with a so-called Level Four or Level Five automation system. A Level Four system indicates “high automation”, referring to the driving mode-specific performance by an automated driving system of all aspects of the dynamic driving task, even if a human user does not respond appropriately to a request to intervene. A Level Five system indicates “full automation”, referring to the full-time performance by an automated driving system of all aspects of the dynamic driving task under all roadway and environmental conditions that can be managed by a human driver. The novel features of the present disclosure are applicable to autonomous and non-autonomous vehicles. In an autonomous vehicle, the system 50 of the present disclosure would only function when the vehicle is being operated in a manual mode (non-autonomous), wherein the driver is in control of all aspects of driving the vehicle 10.

As shown, the vehicle 10 generally includes a propulsion system 20, a transmission system 22, a steering system 24, a brake system 26, a sensor system 28, an actuator system 30, at least one data storage device 32, a system controller 34, and a wireless communication module 36. In an embodiment in which the vehicle 10 is an electric vehicle, there may be no transmission system 22. The propulsion system 20 may, in various embodiments, include an internal combustion engine, an electric machine such as a traction motor, and/or a fuel cell propulsion system. The propulsion system 20 further includes controllers/actuators adapted to control an acceleration pedal 20A, communication between a system controller 34 and the accelerator pedal 20A, and acceleration of the vehicle 10. The system controller 34 is adapted to communicate directly with such controllers/actuators to control acceleration of the vehicle 10 independently of the acceleration pedal 20A. The transmission system 22 is configured to transmit power from the propulsion system 20 to the vehicle's front wheels 16 and rear wheels 18 according to selectable speed ratios. According to various embodiments, the transmission system 22 may include a step-ratio automatic transmission, a continuously-variable transmission, or other appropriate transmission. The brake system 26 is configured to provide braking torque to the vehicle's front wheels 16 and rear wheels 18. The brake system 26 may, in various embodiments, include friction brakes, brake by wire, a regenerative braking system such as an electric machine, and/or other appropriate braking systems. The brake system 26 further includes controllers/actuators adapted to control a brake pedal 26A, communication between the system controller 34 and the brake pedal 26A, and braking of the vehicle 10. The system controller 34 is adapted to communicate directly with such controllers/actuators to control braking of the vehicle 10 independently of the brake pedal 26A. The steering system 24 influences a position of the front wheels 16 and rear wheels 18. While depicted as including a steering wheel for illustrative purposes, in some embodiments contemplated within the scope of the present disclosure, such as for a fully autonomous vehicle, the steering system 24 may not include a steering wheel 24A. The steering system 24 further includes controllers/actuators adapted to control a steering wheel 24A, communication between the system controller 34 and the steering wheel 24A, and steering of the vehicle 10. The system controller 34 is adapted to communicate directly with such controllers/actuators to control steering of the vehicle 10 independently of the steering wheel 24A.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, and/or other sensors. The cameras can include two or more digital cameras spaced at a selected distance from each other, in which the two or more digital cameras are used to obtain stereoscopic images of the surrounding environment in order to obtain a three-dimensional image or map. The plurality of sensing devices 40a-40n is used to determine information about an environment surrounding the vehicle 10.

In an exemplary embodiment, the plurality of sensing devices 40a-40n includes at least one of a motor speed sensor, a motor torque sensor, an electric drive motor voltage and/or current sensor, an accelerator pedal position sensor, a brake pedal position sensor, a coolant temperature sensor, a cooling fan speed sensor, and a transmission oil temperature sensor. In another exemplary embodiment, the plurality of sensing devices 40a-40n further includes sensors to determine information about the environment surrounding the vehicle 10, for example, an ambient air temperature sensor, a barometric pressure sensor, and/or a photo and/or video camera which is positioned to view the environment in front of the vehicle 10. In another exemplary embodiment, at least one of the plurality of sensing devices 40a-40n is capable of measuring distances in the environment surrounding the vehicle 10.

The sensor system 28 communicates with a driver monitoring system 36. The driver monitoring system 52 within the vehicle 10 is adapted to monitor behavior of the driver of the vehicle 10. Driver-monitoring systems typically use a driver-facing camera equipped with infrared light-emitting diodes (LEDs) or lasers so that it can “see” the driver's face, even at night, and see the driver's eyes even if the driver is wearing dark sunglasses. Advanced on-board software collects data points from the driver and creates an initial baseline of what the driver's normal, attentive state looks like. The software can then determine whether the driver is blinking more than usual, whether the eyes are narrowing or closing, and whether the head is tilting at an odd angle. It can also determine whether the driver is looking at the road ahead, and whether the driver is actually paying attention or just absent-mindedly staring. The driver monitoring system 36 uses cameras and sensors to monitor behaviors of the driver including, but not limited to eye gaze behavior/patterns, body posture and hand locations. The driver monitoring system 36 may further monitor physiological characteristics of the driver such as, but not limited to, heartrate, respiration, galvanic skin response, EEG and skin temperature.

The system controller 34 uses information gathered by the driver monitoring system 36 to determine if the driver of the vehicle 10 is distracted (not paying attention, looking away, reaching to the back seat, drowsy, intoxicated, experiencing biomedical or other fitness distress, etc.).

The system controller 34 includes at least one processor 44 and a computer readable storage device or media 46. The at least one data processor 44 can be any custom made or commercially available processor, a central processing unit (CPU), a graphics processing unit (GPU), an auxiliary processor among several processors associated with the vehicle controller 34, a semi-conductor based microprocessor (in the form of a microchip or chip set), a macro-processor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the at least one data processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which includes an ordered listing of executable instructions for implementing logical functions. The instructions, when executed by the at least one processor 44, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although only one controller 34 is shown in FIG. 1, embodiments of the vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

In various embodiments, one or more instructions of the vehicle controller 34 are embodied in a trajectory planning system and, when executed by the at least one data processor 44, using a global positioning system 52 (GPS), generates a trajectory output that addresses kinematic and dynamic constraints of the environment. For example, the instructions receive as input process sensor and map data.

The wireless communication module 38 is configured to wirelessly communicate information to and from other remote entities 48, such as but not limited to, other vehicles (“V2V” communication,) infrastructure (“V2I” communication), remote systems, remote servers, cloud computers, and/or personal devices. In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The system controller 34 is a non-generalized, electronic control device having a preprogrammed digital computer or processor, memory or non-transitory computer readable medium used to store data such as control logic, software applications, instructions, computer code, data, lookup tables, etc., and a transceiver [or input/output ports]. Computer readable medium includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device. Computer code includes any type of program code, including source code, object code, and executable code.

A human machine interface (HMI) 54 within the vehicle 10 facilitates communication between a driver within the vehicle 10 and the system controller 34. The HMI 54 includes a display screen adapted to display messages for the driver. The display screen may be a touch screen display, providing the ability for a driver within the vehicle 10 to input information and preferences to the system controller 34. The HMI 54 may further include speakers adapted to provide audible alerts and messages to the driver within the vehicle 10, and a microphone, adapted to allow the driver to provide audible input to the system controller 34.

The system controller 34 is in communication with the plurality of sensors 40a-40n and is adapted to receive data, from the plurality of sensors 40a-40 within the vehicle 10, related to operating conditions of the vehicle 10. The data will include information such as vehicle speed, acceleration, location and planned destination obtained from onboard trajectory planning systems and global positioning systems (GPS) 52, and information related to the surroundings of the vehicle 10 such as, what lane the vehicle is travelling in, weather conditions that may affect safety thresholds and the presence of other vehicles, objects and vulnerable road users (VRU)(pedestrians) in proximity to the vehicle 10.

The system controller 34 further detects, via communication with the plurality of sensors 40a-40n and systems within the vehicle 10 such as the propulsion system 20, steering system 24 and brake system 26, an input received from the driver of the vehicle 10. Once the system controller 34 detects an input from the driver, the system controller 34 determines if the input received from the driver is an implausible action. To do this, the system controller 34 uses the data received from the plurality of sensors 40a-40n to determine if the input from the driver makes sense, and more importantly, if the received input from the driver creates a risk of a collision event with another vehicle, an object in or near the lane within which the vehicle 10 is travelling and VRUs that may be in proximity to the vehicle 10. In addition to real-time data received from the plurality of sensors 40a-40n, and data from GPS and mapping applications (onboard or remote via the wireless communication module 38), the system controller 34 may access onboard or remote databases of data related to past occurrences of the vehicle 10 travelling on that road, at that time and under the same weather and operating conditions, and data related to past occurrences of other vehicles travelling on that road, at that time and under the same weather and operating conditions, and using machine learning based algorithms, use such data to analyze the input to determine if the input is an implausible action.

When the system controller 34 determines that the input received from the driver of the vehicle 10 is implausible, the system controller 34 will disable inhibit software within the system controller 34, enabling intervention by the system controller 34, and intervene, by taking control of at least one vehicle system, to resolve the implausible driver input.

Advanced driver assistance systems (ADAS) are generally adapted to intervene and provide alerts and/or temporarily take over control of certain vehicle systems, such as brakes, propulsion (accelerator) and steering, when the system determines that the vehicle is operating in an inadvertent manner, such as drifting away from centerline of a roadway lane. ADAS systems include inhibit software that prevents the system from intervening when a driver takes deliberate action.

By way of a non-limiting example, an advanced driver assistance system (ADAS) is adapted to intervene during situations where the system determines intervention must occur to correct an action that may not be intended by the driver and/or the driver is not aware of, such as when a vehicle drifts away from center of a lane within which the vehicle 10 is travelling. ADAS features are included within and controlled by the system controller 34. When a vehicle 10 begins to drift gradually toward an edge of the lane, the ADAS lane keeping assist features will alert a driver that the vehicle 10 is drifting, and may, in certain circumstances, temporarily take control of the steering wheel 24A to bring the vehicle 10 back to center of the lane. ADAS inhibit software, as discussed above, blocks the system from taking control of vehicle systems when the action is perceived as intentional by the driver. Thus, if the driver deliberately moves the steering wheel to steer the vehicle toward the edge of the lane, the inhibit software will prevent the lane keeping assist features of the ADAS from intervening. Therefore, when the system 50 of the present disclosure determines that the input from the driver (perceived as a deliberate action) is implausible, and may put the vehicle 10 at risk for a collision event, the system controller 34 disables the ADAS inhibit software, enabling the system controller 34 to take control of one or more vehicle systems when the system controller 34 determines such action is necessary.

In an exemplary embodiment, the system controller 34 is adapted to detect actuation, by the driver, of a turn signal. Actuation of a turn signal may occur when a driver within the vehicle 10 intentionally moves a turn signal stalk to actuate a left or right turn signal. This actuation is communicated, via a turn signal control module 56 to the system controller 34. Alternatively, in some vehicles, turn signals can be actuated simply by tapping the turn signal stalk. This actuates the turn signal, which will automatically turn itself off after a pre-set time, such as ten seconds. One disadvantage of the tapped actuation is that it cannot be selectively deactivated once actuated. So, even if the driver realizes that they accidentally tapped the turn signal stalk, they cannot deactivate the turn signal and must let it time out (ten seconds).

When determining if the input received from the driver is an implausible action the system controller 34 determines if the actuation of the turn signal by the driver is an implausible action. The system controller 34 must determine if the actuation of the turn signal makes sense, and more importantly, if the actuation of the turn signal could create a risk of a collision event. Thus, the system controller 34 will determine that the input is implausible if, based on the data received from the plurality of sensors 40a-40n, the actuation of the turn signal does not make sense, and, if the driver actually proceeded with the turn, could create a risk of a collision event.

For example, the driver of the vehicle 10 is travelling on a roadway. The driver is travelling in a middle lane of a three-lane roadway. No other vehicles are nearby. The driver actuates, either inadvertently or intentionally, the turn signal indicating an intended left turn. The system controller 34, determines that, even though there is no upcoming cross road on the left, a plausible trajectory for the vehicle is to change lanes, moving from the center lane to the far left lane on the three-lane roadway. No vehicles are present to cause issue, so the system controller 34 determines that the input from the driver is plausible, and no action is taken.

Alternatively, the driver of the vehicle 10 is travelling on the same roadway, in the far left lane. The driver actuates, either inadvertently or intentionally, the turn signal indicating an intended left turn. The system controller 34, determines that, there is no upcoming cross-road on the left, the vehicle 10 is already in the far left lane, and a guardrail is present along the left lane. The system controller 34 identifies no plausible trajectory for the vehicle involving a left turn, and further, that a left turn would result in collision with the guardrail, thus, the system controller 34 determines that the input from the driver (left turn signal) is an implausible action, wherein, the system controller 34 will intervene, take control of the turn signal actuator 56 and de-activate the left turn signal.

In an exemplary embodiment, the system controller 34 is adapted to intervene for a turn signal activation only on a first attempt. The system controller 34 determines if the detected actuation of the turn signal by the driver has been attempted by the driver more than one time, and when the turn signal has been actuated by the driver more than one time, takes no further action. Thus, if the driver actuates the turn signal, the system controller 34 determines it is an implausible action and de-activates the turn signal, and then, the driver immediately re-actuates the turn signal, the system controller 34 will take no further action. If the driver has intentionally actuated the turn signal more than once, the presumption is that the driver intended to actuate the turn signal, and the system controller 34 will allow it. When the turn signal has been actuated by the driver one time (the first time), the system controller 34 will proceed with disabling software inhibits and intervening to disable the turn signal.

In an exemplary embodiment, when determining if the input received from the driver is an implausible action, the system controller 34 is further adapted to predict and map an apparent trajectory of the vehicle 10, an actual trajectory of the vehicle 10 based on the detected driver input, and plausible trajectories for the vehicle 10. The system controller 34 using data from the plurality of sensors 40a-40n, GPS and any active trajectory planning systems (navigation systems), determines the likely planned trajectory for the vehicle 10 (apparent trajectory). The system controller using data from the plurality of sensors 40a-40n, GPS and the input from the driver, determines the likely planned trajectory if the detected input is implemented (actual trajectory). Finally, the system controller 34 using data from the plurality of sensors 40a-40n, GPS and mapping applications (onboard or remote via wireless communication module 38) determines plausible trajectories for the vehicle that to not create a risk of collision and otherwise, make sense. By comparing an actual trajectory to the identified plausible trajectories, the system controller 34 can determine if the input is an implausible action that puts the vehicle on an actual trajectory that is not a plausible trajectory and may create a risk of a collision event.

In another exemplary embodiment, the system controller 34 is adapted to detect, via communication with the plurality of sensors 40a-40n, simultaneous actuation, by the driver, of a brake pedal 26A and an accelerator pedal 20A, and determine if the simultaneous actuation, by the driver, of the brake pedal 26A and the accelerator pedal 20A is an implausible action.

When making this determination, the system controller 34, using data received from the plurality of sensors 40a-40n and GPS, probabilistically calculates a probability of a collision event in response to simultaneous actuation, by the driver, of the brake pedal and the accelerator pedal. When the probability of a collision event is more than a first threshold and less than a second threshold, the system controller 34 determines that simultaneous actuation, by the driver, of the brake pedal 26A and the accelerator pedal 20A causes a low risk of a collision event, and, when intervening to take control of at least one vehicle system to resolve the implausible driver input, provides, via the HMI 54 within the vehicle 10, an alert for the driver. When the probability of a collision event is more that the second threshold, the system controller 34 determines that simultaneous actuation, by the driver, of the brake pedal 26A and the accelerator pedal 20A causes a high risk of a collision event, and, when intervening to take control of at least one vehicle system to resolve the implausible driver input, de-activates actuation of one of the brake pedal 26A and the accelerator pedal 20A.

For example, a vehicle is travelling along a roadway, and the driver notices that a slow-moving vehicle is within the lane ahead. The driver places a foot onto the brake pedal 26A to slow the vehicle 10 down, but inadvertently pushes simultaneously on both the brake pedal 26A and the accelerator pedal 20A. The system controller 34 receives data from the brake system 26 and the propulsion system 20 indicating that both pedals are being actuated. Actuation of both pedals 20A, 26A could result in the accelerator overpowering the brakes and the vehicle 10 accelerating toward the slow-moving vehicle, rather than slowing down. This creates a risk of collision with the slow-moving vehicle.

Based on the speed of the vehicle and other operating conditions, conditions of the roadway surrounding the vehicle 10, speed difference between the vehicle 10 and the slow-moving vehicle ahead, and other data, the system controller probabilistically calculates the risk of a collision event (between the vehicle 10 and the slow moving vehicle, or the vehicle swerving off road to avoid the slow moving vehicle, etc.). If the probability of a collision event is more than a first threshold, by way of non-limiting example, 5%, but less than a second threshold, by way of non-limiting example, 50%, then the system controller 34 determines that simultaneous actuation, by the driver, of the brake pedal 26A and the accelerator pedal 20A causes a low risk of a collision event.

For example, if the vehicle 10 is travelling at fifty-five miles per hour, and the slow-moving vehicle ahead is moving at fifty miles per hour, the speed differential is small, and the risk of collision with the slow-moving vehicle is present, but low (more than 5%, less than 50%). Thus, when intervening to take control of at least one vehicle system to resolve the implausible driver input, the system controller simply provides a message to the driver, via the HMI 54. The message alerts the driver to the upcoming risk so the driver can react pro-actively to avoid the risk of collision. The alert may include specific information for the driver, such as, “Brake and Accelerator Both Actuated” to alert the driver to the reason for the risk.

Alternatively, if the vehicle 10 is travelling at fifty-five miles per hour, and the slow-moving vehicle ahead is moving at twenty-five miles per hour, the speed differential is more significant, and the risk of collision with the slow-moving vehicle is present, and high (more than 50%). Thus, when intervening to take control of at least one vehicle system to resolve the implausible driver input, the system controller 34 de-activates actuation of one of the brake pedal 26A and the accelerator pedal 20A. When determining the risk level, the system controller 34 identifies the risk being that the accelerator pedal 20A is being applied when only the brake pedal 26A should be applied. This determination is based on the presence of the slow-moving vehicle ahead and the current speed of the vehicle 10, and data of the actual trajectory of the vehicle 10, indicating that the vehicle 10 is traveling along that roadway for a long enough distance that catching up to the slow-moving vehicle in inevitable. Thus, the system controller 34 de-activates the accelerator pedal 20A (electronically interrupting signal from the accelerator pedal 20A to the propulsion system 20) so that only the brake pedal 26A is being actuated.

In an exemplary embodiment, the system controller 34 further provides a message to the driver, via the HMI 54, informing the driver of the risk and the action being taken by the system controller 34 (Accelerator Pedal Deactivated). The intervention by the system controller 34 will continue until the driver stops actuating both the brake pedal 26A and the accelerator pedal 20A simultaneously and/or when the calculated probabilistic risk of a collision event is less than the first threshold (5%).

If the system controller 34 determines that the risk is a low risk, the system controller 34 continuously re-calculates the probabilistic risk of a collision event as conditions change (vehicle speed changes, vehicles get closer, road conditions change). The system controller 34 will continue to display the low risk alert for the driver as long as the calculated risk of a collision event is more than the first threshold (5%), and even as the calculated probabilistic risk increases up to the point that the calculated probabilistic risk exceeds the second threshold (50%) at which time, the system controller 34 will change the probabilistic risk of a collision event to high risk, and intervene accordingly. It should be understood by those skilled in the art that the example first (5%) and second (50%) thresholds are for illustrative purposes. The first and second thresholds could be different than the examples cited. Further, the first and second thresholds may be different for different detected inputs from the driver and may be customized based on preferences provided by the driver. Finally, the first and second thresholds may be adjusted by the system controller in response to operating conditions of the vehicle, environmental conditions surrounding the vehicle, or a detected attention level of the driver.

In another exemplary embodiment, the system controller 34 is adapted to detect, via communication with the plurality of sensors 40a-40n, the GPS 52, and communication with remote entities 48, that the vehicle 10 is located in a controlled environment, such as a mechanic's garage bay or an oil change bay, and further, that at least one vulnerable road user (VRU) is within close proximity to the vehicle 10. The system controller 34 is adapted to detect, via communication with the plurality of sensors 40a-40n, a hard actuation of the accelerator pedal 20A while the vehicle 10 is located in the controlled environment and at least one VRU is in proximity to the vehicle, and to determine if the hard actuation of the accelerator pedal 20A by the driver is an implausible action. For example, when the vehicle 10 is being driven within the parking lot or is being pulled out of a parking space within the parking lot, the driver may inadvertently press the accelerator pedal 20A harder than intended, causing a hard acceleration.

When making this determination, the system controller 34, using data received from the plurality of sensors 40a-40n and GPS, probabilistically calculates a probability of a collision event in response to hard actuation of the accelerator pedal 20A while the vehicle 10 is located in the controlled environment and at least one VRU is in proximity to the vehicle. When the probability of a collision event is more than the first threshold and less than the second threshold, the system controller 34 determines that hard actuation of the accelerator pedal 20A while the vehicle 10 is located in the controlled environment and at least one VRU is in proximity to the vehicle causes a low risk of a collision event, and, when intervening to take control of at least one vehicle system to resolve the implausible driver input, provides, via the HMI 54 within the vehicle 10, an alert for the driver. When the probability of a collision event is more that the second threshold, the system controller 34 determines that hard actuation of the accelerator pedal 20A while the vehicle 10 is located in the controlled environment and at least one VRU is in proximity to the vehicle causes a high risk of a collision event, disables inhibit software of the ADAS features within the system controller 34, and, when intervening to take control of at least one vehicle system to resolve the implausible driver input, limits actuation of the accelerator pedal 20A.

For example, if the vehicle 10 is located within a parking lot and the parking lot is relatively empty, no other vehicles are located near the vehicle 10 and no VRUs are standing near the vehicle 10 or walking within the parking lot in proximity to the vehicle 10. The risk of a collision event due to a hard acceleration by the driver is present, as the parking lot has boundaries and objects (light poles, etc.) within that the vehicle 10 may collide with, but low (more than 5%, less than 50%). Thus, when intervening to take control of at least one vehicle system to resolve the implausible driver input, the system controller 34 simply provides a message to the driver, via the HMI 54. The message alerts the driver to the upcoming risk so the driver can react pro-actively (stop the hard acceleration) to avoid the risk of collision. The alert may include specific information for the driver, such as, “Caution Acceleration within Parking Lot” to alert the driver to the reason for the risk.

Alternatively, if the vehicle 10 is parked or travelling slowing within the parking lot, and there are several other vehicles nearby and possibly one or more VRUs (pedestrians walking to and from their vehicles), the risk of a collision event due to the hard acceleration by the driver is high (more than 50%). Thus, when intervening to take control of at least one vehicle system to resolve the implausible driver input, the system controller 34 limits actuation of the accelerator pedal 20A. This may be accomplished by electronically disconnecting the accelerator pedal 20A from the propulsion system 20A or by limiting other vehicle systems, such as the engine, to control fuel supply or otherwise, to limit acceleration of he vehicle 10. The system controller may completely stop acceleration of the vehicle 10, or may limit the acceleration to a very low level that does not create a measurable risk of a collision event.

When determining the risk level, the system controller 34 identifies the risk being that the accelerator pedal 20A is being applied aggressively when the vehicle is in a controlled environment and VRUs are present. This determination is based on the size of the controlled environment, a current speed of the vehicle 10, how close other vehicles and VRUs are to the vehicle, and data of the actual trajectory of the vehicle 10 (steering wheel angle), indicating that a hard acceleration of the vehicle 10 with the operating and environmental conditions observed at that moment in real time create a probabilistic likelihood that a collision event will occur. Thus, the system controller 34 limits acceleration of the vehicle 10.

In an exemplary embodiment, the system controller 34 further provides a message to the driver, via the HMI 54, informing the driver of the risk of a hard acceleration and the action being taken by the system controller 34 (“Acceleration Being Limited”). The intervention by the system controller 34 will continue until the driver stops attempting the hard acceleration and/or when the calculated probabilistic risk of a collision event is less than the first threshold (5%).

If the system controller 34 determines that the risk is a low risk, the system controller 34 continuously re-calculates the probabilistic risk of a collision event as conditions change (vehicle speed changes, position of nearby vehicles/VRUs changes, steering angles is adjusted). The system controller 34 will continue to display the low risk alert for the driver as long as the calculated risk of a collision event is more than the first threshold (5%).

In another exemplary embodiment, the system controller 34 is further adapted to determine, based on the data received from the plurality of sensors 40a-40n and a driver monitoring system 36, the driver of the vehicle 10 is distracted and to detect, via communication with the plurality of sensors 40a-40n, actuation, by the driver, of at least one of the accelerator pedal 20A and a steering wheel 24A within the vehicle 10 while the driver is distracted. For example, a driver is reaching into a back seat of the vehicle 10, shifting position within a driver seat and leaning over to grab an object behind them. This action may cause the driver to take their eyes off the road, resulting in determination, by the system controller 34, via communication with the driver monitoring system 36, that the driver is distracted. Further, while reaching back, the driver may, when shifting position, inadvertently push the accelerator pedal 20A and/or change the angle of the steering wheel 24A.

When making this determination, the system controller 34, using data received from the plurality of sensors 40a-40n and GPS, probabilistically calculates a probability of a collision event in response to actuation of the accelerator pedal 20A and/or movement of the steering wheel 24A while the driver is distracted. When the probability of a collision event is more than the first threshold and less than the second threshold, the system controller 34 determines that actuation of the accelerator pedal 20A and/or movement of the steering wheel 24A while the driver is distracted causes a low risk of a collision event, and, when intervening to take control of at least one vehicle system to resolve the implausible driver input, provides, via the HMI 54 within the vehicle 10, an alert for the driver.

When the probability of a collision event is more that the second threshold, the system controller 34 determines that actuation of the accelerator pedal 20A and/or movement of the steering wheel 24A while the driver is distracted causes a high risk of a collision event, disables inhibit software of the ADAS features within the system controller 34 (automatic emergency braking (AEB), lane keeping assist (LKA)), and, when intervening to take control of at least one vehicle system to resolve the implausible driver input, the system controller 34 at least one of: limits or de-activates actuation of the accelerator pedal 20A, actuates the brake system 26 to stop movement of the vehicle 10 while the driver is distracted, and actuates the steering system 24 to over-ride movement of the steering wheel 24A by the driver and maintain the vehicle 10 on the apparent trajectory.

For example, if the vehicle 10 is moving slowly within an empty parking lot, the risk of a collision event due to the driver reaching into the back seat and accidentally hitting the accelerator pedal 20A and/or moving the steering wheel 24A is present, as the parking lot has boundaries and objects (light poles, etc.) within that the vehicle 10 may collide with, but low (more than 5%, less than 50%). Thus, when intervening to take control of at least one vehicle system to resolve the implausible driver input, the system controller 34 simply provides a message to the driver, via the HMI 54. The message alerts the driver to the upcoming risk so the driver can react pro-actively (stop activity that is distracting, remove foot from the accelerator pedal 20A, move the steering wheel back to original position) to avoid the risk of collision. The alert may include specific information for the driver, such as, “Pay Attention, Erratic Driving” to alert the driver to the reason for the risk.

Alternatively, if the vehicle 10 is travelling down a roadway, at normal speeds (fifty-five miles per hour) and the driver reaches back into the back seat and accidentally presses the accelerator pedal 20A and/or moves the steering wheel 24A, causing the vehicle to swerve, the risk of a collision event due to the unintended acceleration and/or steering wheel 24A movement is high (more than 50%) due to the speed at which the vehicle 10 is travelling, possible presence of nearby vehicles, etc. Thus, when intervening to take control of at least one vehicle system to resolve the implausible driver input, the system controller 34 may limit or de-activate actuation of the accelerator pedal 20A. This will prevent further acceleration of the vehicle 10 while the driver is distracted. The system controller 34 may further, via enablement of AEB features of the system controller 34, actuate the brake system 26 to slow or stop movement of the vehicle 10 while the driver is distracted. Finally, if necessary, the system controller 34 may actuate, via LKA features of the system controller 34, the steering system 24 to over-ride movement of the steering wheel 24A by the driver and maintain the vehicle 10 on the apparent trajectory.

In an exemplary embodiment, the system controller 34 further provides a message to the driver, via the HMI 54, informing the driver of the risk and the action being taken by the system controller 34 (“Acceleration Being Limited, AEB Active, LKA Active”). The intervention by the system controller 34 will continue until the driver is no longer distracted and/or pressing of the accelerator pedal 20A and movement of the steering wheel stops and the calculated probabilistic risk of a collision event is less than the first threshold (5%).

If the system controller 34 determines that the risk is a low risk, the system controller 34 continuously re-calculates the probabilistic risk of a collision event as conditions change (vehicle speed changes, position of nearby vehicles/VRUs changes, steering angles is adjusted). The system controller 34 will continue to display the low risk alert for the driver as long as the calculated risk of a collision event is more than the first threshold (5%).

In an exemplary embodiment, prior to intervening to take control of at least one vehicle system to resolve the implausible driver input, the system controller 34 is further adapted to verify that enabling conditions are satisfied for intervention by the system controller. Enabling conditions are pre-established conditions that must be met for the system controller 34 to disable inhibit software for the ADAS features within the system controller 34 and to intervene. Such enabling conditions may be, for example, vehicle speed. A detected input from the driver may only be considered, for purposes of actuation of the system 50 of the present disclosure, when the vehicle 10 is travelling above a pre-determined speed. Thus, the vehicle 10 traveling above the pre-determined speed is an enabling condition that must be satisfied before the system controller 34 will proceed with determination that the input is an implausible action and intervention. Different enabling conditions may exist for different detected input by the driver, and enabling conditions may change based on other operating and environmental conditions measured in real-time.

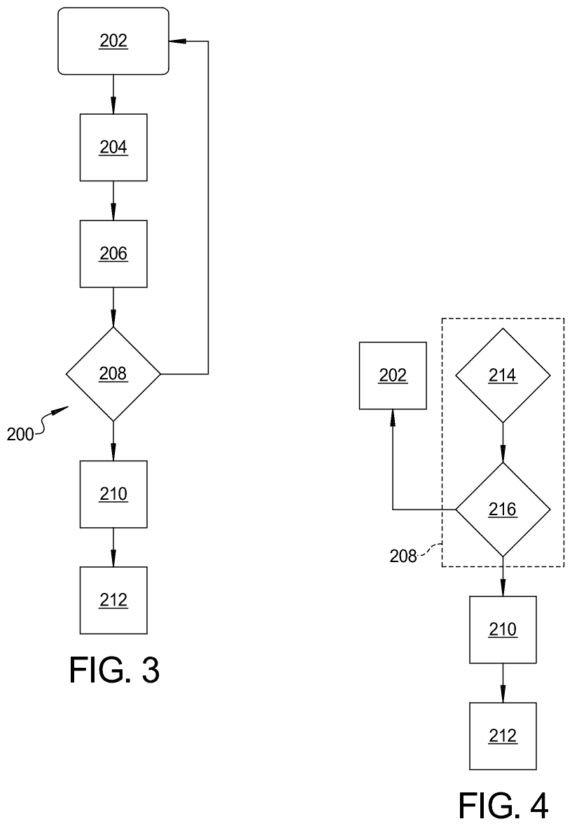

Referring to FIG. 3, a method 200 of intervening and resolving implausible driver input in a vehicle 10 that is being operated in a manual mode includes, beginning at block 202, operating the vehicle in a manual mode of operation, moving to block 204, receiving data, from a plurality of sensors 40a-40n within the vehicle 10, related to operating conditions of the vehicle 10, moving to block 206, detecting, with a system controller 34, via communication with the plurality of sensors 40a-40n, an input received from the driver of the vehicle 10, and, moving to block 208, determining, with the system controller 34, if the input received from the driver is an implausible action.

When, at block 208, the system controller 34 determines that the input received from the driver of the vehicle 10 is not an implausible action, then, moving back to block 202, operation of the vehicle in a manual mode continues. When, at block 208, the system controller 34 determines that the input received from the driver of the vehicle 10 is an implausible action, then, moving to block 210, the method 200 includes disabling inhibit software within the system controller 34, enabling intervention by the system controller 34, and, moving to block 212, intervening, with the system controller 34, control of at least one vehicle system to resolve the implausible driver input.

In an exemplary embodiment, the detecting, with the system controller 34, via communication with the plurality of sensors 40a-40n, an input received from a driver of the vehicle 10 at block 206 further includes detecting, with the system controller 34, via communication with the plurality of sensors 40a-40n, actuation, by the driver, of a turn signal, and the determining, with the system controller 34, if the input received from the driver is an implausible action at block 208 further includes, referring to FIG. 4, moving to block 214, determining, with the system controller 34, that actuation of the turn signal by the driver is an implausible action, moving to block 216, determining, with the system controller 34, if the detected actuation of the turn signal by the driver has been attempted by the driver more than one time, and, when the turn signal has been actuated by the driver more than one time, moving back to block 202, continuing operation of the vehicle 10 in a manual mode of operation, and, when, at block 216, the system controller 34 determines that the turn signal has been actuated by the driver one time, moving to block 210, the method 200 includes disabling inhibit software within the system controller 34, enabling intervention by the system controller 34, and, moving to block 212, intervening, with the system controller 34, control of at least one vehicle system to resolve the implausible driver input by disabling, with the system controller 34, the turn signal.

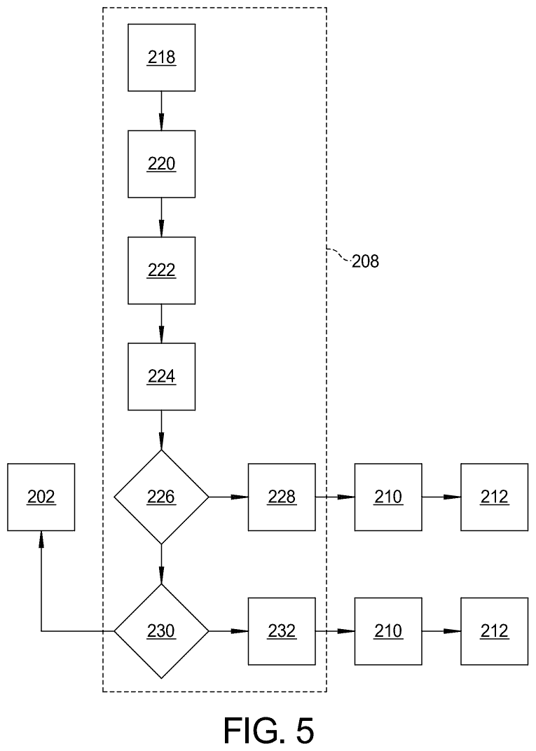

In another exemplary embodiment, the detecting, with the system controller 34, via communication with the plurality of sensors 40a-40n, an input received from the driver of the vehicle 10 at block 206 further includes detecting, with the system controller 34, via communication with the plurality of sensors 40a-40n, simultaneous actuation, by the driver, of a brake pedal 26A and an accelerator pedal 20A, and the determining, with the system controller 34, if the input received from the driver is an implausible action at block 208 further includes, determining if simultaneous actuation, by the driver, of the brake pedal 26A and the accelerator pedal 20A is an implausible action, and, referring to FIG. 5, moving to block 218, predicting and mapping, with the system controller 34, an apparent trajectory of the vehicle 10, moving to block 220, predicting and mapping, with the system controller 34, an actual trajectory of the vehicle 10 based on the detected driver input, and, moving to block 222, predicting and mapping, with the system controller 34, plausible trajectories for the vehicle 10, and, moving to block 224, probabilistically calculating, with the system controller 34, a probability of a collision event in response to simultaneous actuation, by the driver, of the brake pedal 26A and the accelerator pedal 20A.

Moving to block 226, when the probability of a collision event is more than a first threshold and less than a second threshold, the method 200 includes, moving to block 228, determining that simultaneous actuation, by the driver, of the brake pedal 26A and the accelerator pedal 20A causes a low risk of a collision event, and, the intervening, with the system controller 34, control of at least one vehicle system to resolve the implausible driver input at block 212 further includes providing, via a human machine interface (HMI) 54 within the vehicle 10 an alert for the driver.

Moving to block 230, when the probability of a collision event is more that the second threshold, the method 200 includes, moving to block 232, determining that simultaneous actuation, by the driver, of the brake pedal 26A and the accelerator pedal 20A causes a high risk of a collision event, and, the intervening, with the system controller 34, control of at least one vehicle system to resolve the implausible driver input at block 212 further includes de-activating actuation of one of the brake pedal 26A and the accelerator pedal 20A.

In an exemplary embodiment, when the system controller 34 determines that simultaneous actuation, by the driver, of the brake pedal 26A and the accelerator pedal 20A causes a high risk of a collision event, the intervening, with the system controller 34, control of at least one vehicle system to resolve the implausible driver input at block 212 further includes providing, with the system controller 34, via the HMI, an alert notification explaining that both the brake pedal 26A and the accelerator pedal 20A are being actuated and the system controller 34 is de-activating actuation of one of the brake pedal 26A and the accelerator pedal 20A.

In another exemplary embodiment, the detecting, with the system controller 34, via communication with the plurality of sensors 40a-40n, an input received from the driver of the vehicle 10 at block 206 further includes determining, with the system controller 34, based on the data received from the plurality of sensors 40a-40n, a location of the vehicle 10 in a controlled environment and a presence of at least one vulnerable road user (VRU) in proximity to the vehicle 10 and detecting, with the system controller 34, via communication with the plurality of sensors 40a-40n, a hard actuation of the accelerator pedal 20A within the vehicle 10 when the vehicle 10 is located in a controlled environment and at least one VRU is in proximity to the vehicle 10, and the determining, with the system controller 34, if the input received from the driver is an implausible action at block 208 further includes, determining if the hard actuation of the accelerator pedal 20A within the vehicle 10 when the vehicle 10 is located in a controlled environment and at least one VRU is in proximity to the vehicle 10 is an implausible action, and, referring to FIG. 5, moving to block 218, predicting and mapping, with the system controller 34, an apparent trajectory of the vehicle 10, moving to block 220, predicting and mapping, with the system controller 34, an actual trajectory of the vehicle 10 based on the detected driver input, and, moving to block 222, predicting and mapping, with the system controller 34, plausible trajectories for the vehicle 10, and, moving to block 224, probabilistically calculating, with the system controller 34, a probability of a collision event in response to a hard actuation of the accelerator pedal 20A within the vehicle 10 when the vehicle 10 is located in a controlled environment and at least one VRU is in proximity to the vehicle 10.

Moving to block 226, when the probability of a collision event is more than a first threshold and less than a second threshold, the method 200 includes, moving to block 228, determining that hard actuation of the accelerator pedal 20A within the vehicle 10 when the vehicle 10 is located in a controlled environment and at least one VRU is in proximity to the vehicle 10 causes a low risk of a collision event, and, the intervening, with the system controller 34, control of at least one vehicle system to resolve the implausible driver input at block 212 further includes providing, via a human machine interface (HMI) 54 within the vehicle 10 an alert for the driver.

Moving to block 230, when the probability of a collision event is more that the second threshold, the method 200 includes, moving to block 232, determining that hard actuation of the accelerator pedal 20A within the vehicle 10 when the vehicle 10 is located in a controlled environment and at least one VRU is in proximity to the vehicle 10 causes a high risk of a collision event, and, the intervening, with the system controller 34, control of at least one vehicle system to resolve the implausible driver input at block 212 further includes limiting, with the system controller 34, actuation of the accelerator pedal 20A.

In an exemplary embodiment, when the system controller 34 determines that hard actuation of the accelerator pedal 20A within the vehicle 10 when the vehicle 10 is located in a controlled environment and at least one VRU is in proximity to the vehicle 10 causes a high risk of a collision event, the intervening, with the system controller 34, control of at least one vehicle system to resolve the implausible driver input at block 212 further includes providing, with the system controller 34, via the HMI, an alert notification explaining that the system controller 34 will not allow hard acceleration of the vehicle 10 and actuation of the accelerator pedal 20A is being limited.

In another exemplary embodiment, the detecting, with the system controller 34, via communication with the plurality of sensors 40a-40n, an input received from the driver of the vehicle 10 at block 206 further includes determining, with the system controller 34, based on the data received from the plurality of sensors 40a-40n and an driver monitoring system 36, the driver of the vehicle 10 is distracted, and detecting, with the system controller 34, via communication with the plurality of sensors 40a-40n, actuation, by the driver, of at least one of the accelerator pedal 20A and a steering wheel 24A within the vehicle 10 while the driver is distracted, and the determining, with the system controller 34, if the input received from the driver is an implausible action at block 208 further includes, determining if actuation, by the driver, of at least one of the accelerator pedal 20A and a steering wheel 24A within the vehicle 10 while the driver is distracted is an implausible action, and, referring to FIG. 5, moving to block 218, predicting and mapping, with the system controller 34, an apparent trajectory of the vehicle 10, moving to block 220, predicting and mapping, with the system controller 34, an actual trajectory of the vehicle 10 based on the detected driver input, and, moving to block 222, predicting and mapping, with the system controller 34, plausible trajectories for the vehicle 10, and, moving to block 224, probabilistically calculating, with the system controller 34, a probability of a collision event in response to actuation, by the driver, of at least one of the accelerator pedal 20A and a steering wheel 24A within the vehicle 10 while the driver is distracted.

Moving to block 226, when the probability of a collision event is more than a first threshold and less than a second threshold, the method 200 includes, moving to block 228, determining that actuation, by the driver, of at least one of the accelerator pedal 20A and a steering wheel 24A within the vehicle 10 while the driver is distracted causes a low risk of a collision event, and, the intervening, with the system controller 34, control of at least one vehicle system to resolve the implausible driver input at block 212 further includes providing, via a human machine interface (HMI) 54 within the vehicle 10 an alert for the driver.

Moving to block 230, when the probability of a collision event is more that the second threshold, the method 200 includes, moving to block 232, determining that actuation, by the driver, of at least one of the accelerator pedal 20A and a steering wheel 24A within the vehicle 10 while the driver is distracted causes a high risk of a collision event, and, the intervening, with the system controller 34, control of at least one vehicle system to resolve the implausible driver input at block 212 further includes at least one of: limiting or de-activating, with the system controller 34, actuation of the accelerator pedal 20A, actuating, with the system controller 34, a brake system 26 within the vehicle 10, and actuating, with the system controller 34, a steering system 24.

In an exemplary embodiment, when the system controller 34 determines that actuation, by the driver, of at least one of the accelerator pedal 20A and a steering wheel 24A within the vehicle 10 while the driver is distracted causes a high risk of a collision event, the intervening, with the system controller 34, control of at least one vehicle system to resolve the implausible driver input at block 212 further includes providing, with the system controller 34, via the HMI, an alert notification explaining that the system controller 34 is intervening to limit actuation of the accelerator pedal 20A, actuating a brake system 26 within the vehicle 10, and enabling lane keeping assist features of the system controller 34 to override input to the steering wheel 24A.

In another exemplary embodiment, the determining, with the system controller 34, if the input received from the driver is an implausible action at block 208 further includes, prior to the intervening, with the system controller 34, control of at least one vehicle system to resolve the implausible driver input, verifying, with the system controller 34, that enabling conditions are satisfied for intervention by the system controller 34.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method of intervening and resolving implausible driver input in a vehicle that is being operated in a manual mode, comprising:
receiving data, from a plurality of sensors within the vehicle, related to operating conditions of the vehicle;
detecting, with a system controller, via communication with the plurality of sensors, an input received from the driver of the vehicle;
determining, with the system controller, if the input received from the driver is an implausible action; and
when the system controller determines that the input received from the driver of the vehicle is implausible:
disabling inhibit software within the system controller, enabling intervention by the system controller; and
intervening, with the system controller, control of at least one vehicle system to resolve the implausible driver input.

2. The method of claim 1, wherein the detecting, with a system controller, via communication with the plurality of sensors, an input received from a driver of the vehicle further includes detecting, with the system controller, via communication with the plurality of sensors, actuation, by the driver, of a turn signal; and
the determining, with the system controller, if the input received from the driver is an implausible action further includes:
determining, with the system controller, that actuation of the turn signal by the driver is an implausible action;
determining, with the system controller, if the detected actuation of the turn signal by the driver has been attempted by the driver more than one time;
when the turn signal has been actuated by the driver more than one time, taking no further action; and
when the turn signal has been actuated by the driver one time, the intervening, with the system controller, control of at least one vehicle system to resolve the implausible driver input further includes disabling, with the system controller, the turn signal.

3. The method of claim 1, wherein the detecting, with a system controller, via communication with the plurality of sensors, an input received from the driver of the vehicle further includes detecting, with the system controller, via communication with the plurality of sensors, simultaneous actuation, by the driver, of a brake pedal and an accelerator pedal; and
the determining, with the system controller, if the input received from the driver is an implausible action further including determining, with the system controller, if simultaneous actuation, by the driver, of the brake pedal and the accelerator pedal is an implausible action, and:
probabilistically calculating, with the system controller, a probability of a collision event in response to simultaneous actuation, by the driver, of the brake pedal and the accelerator pedal;
when the probability of a collision event is more than a first threshold and less than a second threshold:
determining that simultaneous actuation, by the driver, of the brake pedal and the accelerator pedal causes a low risk of a collision event; and
the intervening, with the system controller, control of at least one vehicle system to resolve the implausible driver input further includes providing, via a human machine interface (HMI) within the vehicle an alert for the driver; and
when the probability of a collision event is more than the second threshold:
determining that simultaneous actuation, by the driver, of the brake pedal and the accelerator pedal causes a high risk of a collision event; and
the intervening, with the system controller, control of at least one vehicle system to resolve the implausible driver input further includes de-activating actuation of one of the brake pedal and the accelerator pedal.

4. The method of claim 3, wherein, when the system controller determines that simultaneous actuation, by the driver, of the brake pedal and the accelerator pedal causes a high risk of a collision event, the intervening, with the system controller, control of at least one vehicle system to resolve the implausible driver input further includes providing, with the system controller, via the HMI, an alert notification explaining that both the brake pedal and the accelerator pedal are being actuated and the system is de-activating actuation of one of the brake pedal and the accelerator pedal.

5. The method of claim 1, wherein:
the detecting, with a system controller, via communication with the plurality of sensors, an input received from the driver of the vehicle further includes determining, with the system controller, based on the data received from the plurality of sensors, a location of the vehicle in a controlled environment and a presence of at least one vulnerable road user (VRU) in proximity to the vehicle and detecting, with the system controller, via communication with the plurality of sensors, a hard actuation of an accelerator pedal within the vehicle when the vehicle is located in a controlled environment and at least one VRU is in proximity to the vehicle; and
the determining, with the system controller, if the input received from the driver is an implausible action further including determining, with the system controller, if the hard actuation of the accelerator pedal by the driver is an implausible action, and:
probabilistically calculating, with the system controller, a probability of a collision event in response to the hard actuation of the accelerator pedal;
when the probability of a collision event is more than a first threshold and less than a second threshold:
determining that the hard actuation of the accelerator pedal causes a low risk of a collision event; and
the intervening, with the system controller, control of at least one vehicle system to resolve the implausible driver input further includes providing, via a human machine interface (HMI) within the vehicle an alert for the driver; and
when the probability of a collision event is more that the second threshold:
determining that the hard actuation of the accelerator pedal by the driver causes a high risk of a collision event; and
the intervening, with the system controller, control of at least one vehicle system to resolve the implausible driver input further includes limiting, with the system controller, actuation of the accelerator pedal.

6. The method of claim 5, wherein, when the system controller determines that the hard actuation of the accelerator pedal causes a high risk of a collision event, the intervening, with the system controller, control of at least one vehicle system to resolve the implausible driver input further includes providing, with the system controller, via the HMI, an alert notification explaining that the system will not allow hard acceleration of the vehicle and actuation of the accelerator pedal is being limited.

7. The method of claim 1, wherein:
the detecting, with a system controller, via communication with the plurality of sensors, an input received from the driver of the vehicle further includes determining, with the system controller, based on the data received from the plurality of sensors and a driver monitoring system, the driver of the vehicle is distracted, and, detecting, with the system controller, via communication with the plurality of sensors, actuation, by the driver, of at least one of an accelerator pedal and a steering wheel within the vehicle while the driver is distracted; and
the determining, with the system controller, if the input received from the driver is an implausible action further including determining, with the system controller, if the actuation, by the driver, of at least one of an accelerator pedal and a steering wheel within the vehicle is an implausible action, and:
probabilistically calculating, with the system controller, a probability of a collision event in response to the actuation, by the driver, of at least one of the accelerator pedal and the steering wheel within the vehicle;
when the probability of a collision event is more than a first threshold and less than a second threshold:
determining that the actuation, by the driver, of at least one of the accelerator pedal and the steering wheel within the vehicle causes a low risk of a collision event; and
the intervening, with the system controller, control of at least one vehicle system to resolve the implausible driver input further includes providing, via a human machine interface (HMI) within the vehicle, an alert for the driver; and
when the probability of a collision event is more that the second threshold:
determining that the actuation, by the driver, of at least one of the accelerator pedal and the steering wheel within the vehicle causes a high risk of a collision event; and
the intervening, with the system controller, control of at least one vehicle system to resolve the implausible driver input further includes at least one of:
de-activating, with the system controller, actuation of the accelerator pedal;
actuating, with the system controller, a brake system within the vehicle; and
actuating, with the system controller, a steering system.

8. The method of claim 7, wherein, when the system controller determines that actuation, by the driver, of at least one of the accelerator pedal and the steering wheel within the vehicle causes a high risk of a collision event, the intervening, with the system controller, control of at least one vehicle system to resolve the implausible driver input further includes providing, with the system controller, via the HMI, an alert notification explaining that the system controller is intervening to limit actuation of the accelerator pedal, actuating a brake system within the vehicle, and enabling lane keeping assist features of the system controller to override input to the steering wheel.

9. The method of claim 1, wherein the determining, with the system controller, if the input received from the driver is an implausible action further includes, prior to the intervening, with the system controller, control of at least one vehicle system to resolve the implausible driver input, verifying, with the system controller, that enabling conditions are satisfied for intervention by the system controller.

10. The method of claim 1, wherein the determining, with the system controller, if the input received from the driver is an implausible action further includes predicting and mapping, with the system controller, an apparent trajectory of the vehicle, an actual trajectory of the vehicle based on the detected driver input, and plausible trajectories for the vehicle.

11. A system for intervening and resolving implausible driver input in a vehicle that is being operated in a manual mode, comprising:
a system controller in communication with a plurality of sensors within the vehicle, the system controller adapted to:
receive data, from the plurality of sensors within the vehicle, related to operating conditions of the vehicle;
detect, via communication with the plurality of sensors, an input received from the driver of the vehicle;
determine if the input received from the driver is an implausible action; and
when the system controller determines that the input received from the driver of the vehicle is implausible:
disable inhibit software within the system controller, enabling intervention by the system controller; and
intervene, by taking control of at least one vehicle system, to resolve the implausible driver input.

12. The system of claim 11, wherein the system controller is adapted to:
detect actuation, by the driver, of a turn signal; and
when determining if the input received from the driver is an implausible action:
determine if actuation of the turn signal by the driver is an implausible action;
determine, with the system controller, if the detected actuation of the turn signal by the driver has been attempted by the driver more than one time;
when the turn signal has been actuated by the driver more than one time, take no further action; and
when the turn signal has been actuated by the driver one time, when intervening to take control of at least one vehicle system to resolve the implausible driver input, the system controller is further adapted to disable the turn signal.

13. The system of claim 11, wherein, when detecting, via communication with the plurality of sensors, an input received from the driver of the vehicle, the system controller is further adapted to detect, via communication with the plurality of sensors, simultaneous actuation, by the driver, of a brake pedal and an accelerator pedal; and
when determining if the input received from the driver is an implausible action, the system controller is further adapted to determine if simultaneous actuation, by the driver, of the brake pedal and the accelerator pedal is an implausible action, and:
probabilistically calculate a probability of a collision event in response to simultaneous actuation, by the driver, of the brake pedal and the accelerator pedal;
when the probability of a collision event is more than a first threshold and less than a second threshold, determine that simultaneous actuation, by the driver, of the brake pedal and the accelerator pedal causes a low risk of a collision event, and, when intervening to take control of at least one vehicle system to resolve the implausible driver input, provide, via a human machine interface (HMI) within the vehicle, an alert for the driver; and
when the probability of a collision event is more that the second threshold, determine that simultaneous actuation, by the driver, of the brake pedal and the accelerator pedal causes a high risk of a collision event, and, when intervening to take control of at least one vehicle system to resolve the implausible driver input, de-activate actuation of one of the brake pedal and the accelerator pedal.

14. The system of claim 13, wherein, when the system controller determines that simultaneous actuation, by the driver, of the brake pedal and the accelerator pedal causes a high risk of a collision event, when intervening to take control of at least one vehicle system to resolve the implausible driver input, the system controller is further adapted to provide, via the HMI, an alert notification explaining that both the brake pedal and the accelerator pedal are being actuated and the system controller is de-activating actuation of one of the brake pedal and the accelerator pedal.

15. The system of claim 11, wherein the system controller is further adapted to determine, based on the data received from the plurality of sensors, a location of the vehicle in a controlled environment and a presence of at least one vulnerable road user (VRU) in proximity to the vehicle;
wherein, when detecting, via communication with the plurality of sensors, an input received from the driver of the vehicle, the system controller is adapted to detect, via communication with the plurality of sensors, a hard actuation of an accelerator pedal within the vehicle when the vehicle is located in a controlled environment and at least one VRU is in proximity to the vehicle; and
when determining if the input received from the driver is an implausible action, the system controller is further adapted to determine if the hard actuation of the accelerator pedal by the driver is an implausible action, and:
probabilistically calculate a probability of a collision event in response to the hard actuation of the accelerator pedal;
when the probability of a collision event is more than a first threshold and less than a second threshold, determine that the hard actuation of the accelerator pedal causes a low risk of a collision event, and, when intervening to take control of at least one vehicle system to resolve the implausible driver input, provide, via a human machine interface (HMI) within the vehicle an alert for the driver; and
when the probability of a collision event is more that the second threshold, determine that the hard actuation of the accelerator pedal by the driver causes a high risk of a collision event, and, when intervening to take control of at least one vehicle system to resolve the implausible driver input, limit actuation of the accelerator pedal.

16. The system of claim 15, wherein, when the system controller determines that the hard actuation of the accelerator pedal causes a high risk of a collision event, when intervening to take control of at least one vehicle system to resolve the implausible driver input, the system controller is further adapted to provide, via the HMI, an alert notification explaining that the system controller will not allow hard acceleration of the vehicle and actuation of the accelerator pedal is being limited.

17. The system of claim 11, wherein the system controller is further adapted to determine, based on the data received from the plurality of sensors and an occupant monitoring system, the driver of the vehicle is distracted;
wherein, when detecting, via communication with the plurality of sensors, an input received from the driver of the vehicle, the system controller is further adapted to detect, via communication with the plurality of sensors, actuation, by the driver, of at least one of an accelerator pedal and a steering wheel within the vehicle while the driver is distracted; and
when determining if the input received from the driver is an implausible action, the system controller is further adapted to determine if the actuation, by the driver, of at least one of an accelerator pedal and a steering wheel within the vehicle is an implausible action, and probabilistically calculate a probability of a collision event in response to the actuation, by the driver, of at least one of the accelerator pedal and the steering wheel within the vehicle; and
wherein, when the probability of a collision event is more than a first threshold and less than a second threshold, determine that the actuation, by the driver, of at least one of the accelerator pedal and the steering wheel within the vehicle causes a low risk of a collision event, and, when intervening to take control of at least one vehicle system to resolve the implausible driver input, to provide, via a human machine interface (HMI) within the vehicle, an alert for the driver; and
when the probability of a collision event is more that the second threshold, determine that the actuation, by the driver, of at least one of the accelerator pedal and the steering wheel within the vehicle causes a high risk of a collision event, and, when intervening to take control of at least one vehicle system to resolve the implausible driver input, at least one of de-activate actuation of the accelerator pedal, actuate brakes within the vehicle, and actuate a steering system.

18. The system of claim 17, wherein, when the system controller determines that actuation, by the driver, of at least one of the accelerator pedal and the steering wheel within the vehicle causes a high risk of a collision event, when intervening to take control of at least one vehicle system to resolve the implausible driver input, the system controller is further adapted to provide, via the HMI, an alert notification explaining that the system controller is intervening to prevent actuation of the accelerator pedal and enabling lane-assist features within the vehicle to override input to the steering wheel.

19. The system of claim 11, wherein, prior to the intervening to take control of at least one vehicle system to resolve the implausible driver input, the system controller is further adapted to verify that enabling conditions are satisfied for intervention by the system controller; and
when determining if the input received from the driver is an implausible action, the system controller is further adapted to predict and map an apparent trajectory of the vehicle, an actual trajectory of the vehicle based on the detected driver input, and plausible trajectories for the vehicle.

20. A vehicle having a system for intervening and resolving implausible driver input when the vehicle is being operated in a manual mode, comprising:
a system controller in communication with a plurality of sensors within the vehicle, the system controller adapted to:
receive data, from the plurality of sensors within the vehicle, related to operating conditions of the vehicle;
detect, via communication with the plurality of sensors, an input received from the driver of the vehicle, the input being one of:
actuation, by the driver, of a turn signal;
simultaneous actuation, by the driver, of a brake pedal and an accelerator pedal;
a hard actuation of an accelerator pedal within the vehicle when the vehicle is located in a controlled environment and at least one VRU is in proximity to the vehicle; or
actuation, by the driver, of at least one of an accelerator pedal and a steering wheel within the vehicle while the driver is distracted;
determine if the input received from the driver is an implausible action; and
when the system controller determines that the input received from the driver of the vehicle is implausible:
when the input is actuation, by the driver, of a turn signal, determine if the detected actuation of the turn signal by the driver has been attempted by the driver more than one time, and, when the turn signal has been actuated by the driver one time, disable inhibit software within the system controller, enabling intervention by the system controller, and disable the turn signal;
when the input is one of simultaneous actuation, by the driver, of a brake pedal and an accelerator pedal, a hard actuation of an accelerator pedal within the vehicle when the vehicle is located in a controlled environment and at least one VRU is in proximity to the vehicle, or actuation, by the driver, of at least one of an accelerator pedal and a steering wheel within the vehicle while the driver is distracted:
probabilistically calculate a probability of a collision event in response to simultaneous actuation, by the driver, of the brake pedal and the accelerator pedal;
when the probability of a collision event is more than a first threshold and less than a second threshold, determine that the input causes a low risk of a collision event, and when the probability of a collision event is more that the second threshold, determine that the input causes a high risk of a collision event; and
when the input is simultaneous actuation, by the driver, of a brake pedal and an accelerator pedal:
when simultaneous actuation, by the driver, of the brake pedal and the accelerator pedal causes a low risk of a collision event, provide, via a human machine interface (HMI) within the vehicle, an alert for the driver; and
when simultaneous actuation, by the driver, of the brake pedal and the accelerator pedal causes a high risk of a collision event, disable inhibit software within the system controller, enabling intervention by the system controller, de-activate actuation of one of the brake pedal and the accelerator pedal, and provide, via the HMI, an alert informing the driver of action being taken by the system controller;
when the input is a hard actuation of an accelerator pedal within the vehicle when the vehicle is located in a controlled environment and at least one vulnerable road user (VRU) is in proximity to the vehicle:
when hard actuation of the accelerator pedal causes a low risk of a collision event, provide, via the HMI, an alert for the driver; and
when hard actuation of the accelerator pedal by the driver causes a high risk of a collision event, disable inhibit software within the system controller, enabling intervention by the system controller, limit actuation of the accelerator pedal, and provide, via the HMI, an alert informing the driver of action being taken by the system controller;
when the input is actuation, by the driver, of at least one of an accelerator pedal and a steering wheel within the vehicle while the driver is distracted:
when the actuation, by the driver, of at least one of the accelerator pedal and the steering wheel within the vehicle causes a low risk of a collision event, provide, via a human machine interface (HMI) within the vehicle, an alert for the driver; and
when the actuation, by the driver, of at least one of the accelerator pedal and the steering wheel within the vehicle causes a high risk of a collision event, disable inhibit software within the system controller, enabling intervention by the system controller, and at least one of de-activate actuation of the accelerator pedal, actuate brakes within the vehicle, and actuate a steering system, and, provide, via the HMI, an alert informing the driver of action being taken by the system controller.
